(19) United States
(12) Patent Application Publication
(10) Pub. No.: US 2005/0111023 A1
(43) Pub. Date: May 26, 2005

(54) Systems and methods for controlling device printing modes

(76) Inventors: Shell S. Simpson, Boise, ID (US); Eugene A. R. Ylance, Boise, ID (US); Robert E. Haines, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/721,982

(22) Filed: Nov. 25, 2003

(51) Int. Cl. G06F 15/00

(52) U.S. Cl. 358/1.13

(57) ABSTRACT

In one embodiment, a system and a method for controlling device printing modes pertain to receiving a request to change a printing mode of a printing device, generating a signed request that requests changing of the printing mode, validating the signed request, and enabling or disabling the printing mode in accordance with the signed request if the signed request is valid.

### BACKGROUND

Print quality is typically a primary concern for most printing device customers. In some situations, however, reducing toner usage may be even more important than obtaining the best possible print quality. Toner usage can be reduced by implementing reduced-toner printing. With reduced-toner printing, the toner used to produce print jobs is reduced so that the life of the printing device toner cartridges may be extended to reduce maintenance costs. Although less toner is used for each print job, relatively high-quality results are still obtainable for most print jobs.

Reduced-toner printing is often desired by service providers who maintain printing devices for their clients. In such an arrangement, the service provider may contract with a business or other entity to maintain their printing devices including providing all consumable resources (such as toner) for the devices.

Given that reduced-toner printing does reduce print quality to some degree, the printing device manufacturer may wish to exercise control over which persons can configure printing devices made by the manufacturer for reduced-toner printing so as to avoid customer dissatisfaction with print quality. In similar manner, a service provider who maintains a group of printing devices may likewise wish to exercise control over which persons can reconfigure the devices the provider maintains for standard mode printing. Previously, such control has been exercised by requiring input of a secret code into the printing device before the printing mode can be changed so as to limit the number of persons who can make such a change. Unfortunately, if that secret code becomes public, control over the printing mode for a given printer may no longer be possible.

### SUMMARY

Disclosed are systems and methods for controlling device printing modes. In one embodiment, a system and a method pertain to receiving a request to change a printing mode of a printing device, generating a signed request that requests changing of the printing mode, validating the signed request, and enabling or disabling the printing mode in accordance with the signed request if the signed request is valid.

### BRIEF DESCRIPTION OF THE DRAWINGS

The systems and methods can be better understood with reference to the following drawings. The components in the drawings are not necessarily to scale.

FIG. 1 is a schematic view of an embodiment of a system in which device printing modes can be controlled.

FIG. 2 is a block diagram of an embodiment of a printing device shown in FIG. 1.

FIG. 3 is a block diagram of an embodiment of a server computer shown in FIG. 1.

FIG. 4 is a flow diagram that illustrates an embodiment of controlling printing modes using the system shown in FIG. 1.

FIG. 5 is a flow diagram that illustrates an embodiment of operation of a request generator shown in FIG. 3 in generating a request to change a device printing mode.

FIG. 6 is a flow diagram that illustrates an embodiment of operation of a request validator shown in FIG. 2 in validating a signed request and enabling or disabling a printing mode.

### DETAILED DESCRIPTION

Disclosed are systems and methods through which a printing mode of a printing device can be controlled. As is described in greater detail below, a secure procedure may be used to verify that authorization to change the printing mode is possessed before any change is made to the present mode. By way of example, the secure procedure can be used by service providers who maintain printing devices for their clients to enable or disable reduced-toner printing.

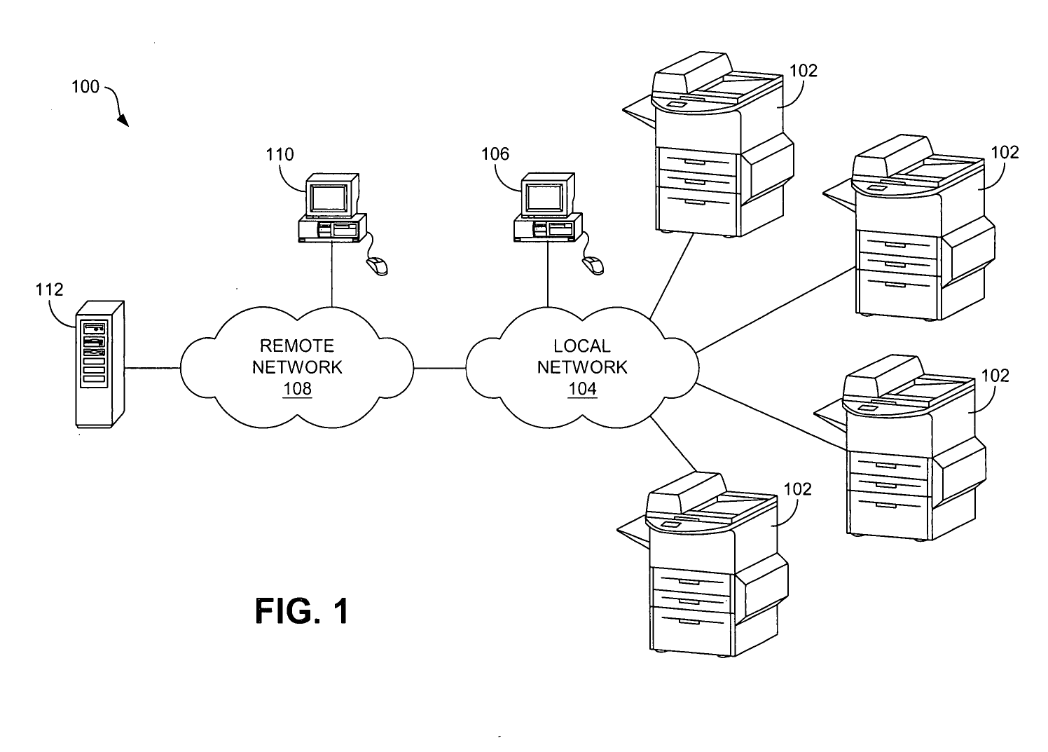

Referring now in more detail to the figures in which like numerals identify corresponding parts, FIG. 1 illustrates an example system 100 with which device printing modes can be controlled. As indicated in this figure, the system 100 generally comprises one or more printing devices 102 that are connected to a local network 104. The printing devices 102 comprise any device that can receive data and generate hard copy outputs based upon the received data. As indicated in FIG. 1, the printing devices 102 may comprise printers. Although printers are illustrated in FIG. 1 and have been explicitly identified herein, the printing devices may be other devices including, for example, photocopying devices, multi-function peripheral (MFP) devices (or “all-in-one” devices), facsimile devices, or similar devices. Depending upon the operating environment, each of the printing devices 102 of a group (a group of four being depicted in FIG. 1) may be of the same make and model. Alternatively, however, the printing devices 102 may be different.

In some embodiments, the printing devices 102 are all located at the same location, for instance a business office. In such a case, the local network 104 may comprise a local area network (LAN) that has been established at that location. In other embodiments, the printing devices 102 may be located at different locations, for instance different locations of a single company. Regardless, it is assumed that each printing device 102 is maintained by a given service provider who wishes to exercise control over activation of printing modes for the devices.

As is further indicated in FIG. 1, a local computing device 106, such as a personal computer (PC), may also be connected to the local network 104. As is described below, that computing device 106 may, optionally, be used by a service provider to both initiate and facilitate completion of a printing mode change.

The local network 104 is shown connected to a remote network 108, which, for example, comprises a wide area network (WAN) that forms part of the public Internet. Connected to that network 108 is a further computing device 110 and a server computer 112. As with the computing device 106, the computing device 110 may, optionally, be used by a service provider to both initiate and facilitate completion of a printing mode change. As is described below in greater detail, the server computer 112 is used to generate signed requests that may be used to request change of an existing printing mode. By way of example, the server computer 112 is maintained by or on the behalf of the printing device manufacturer.

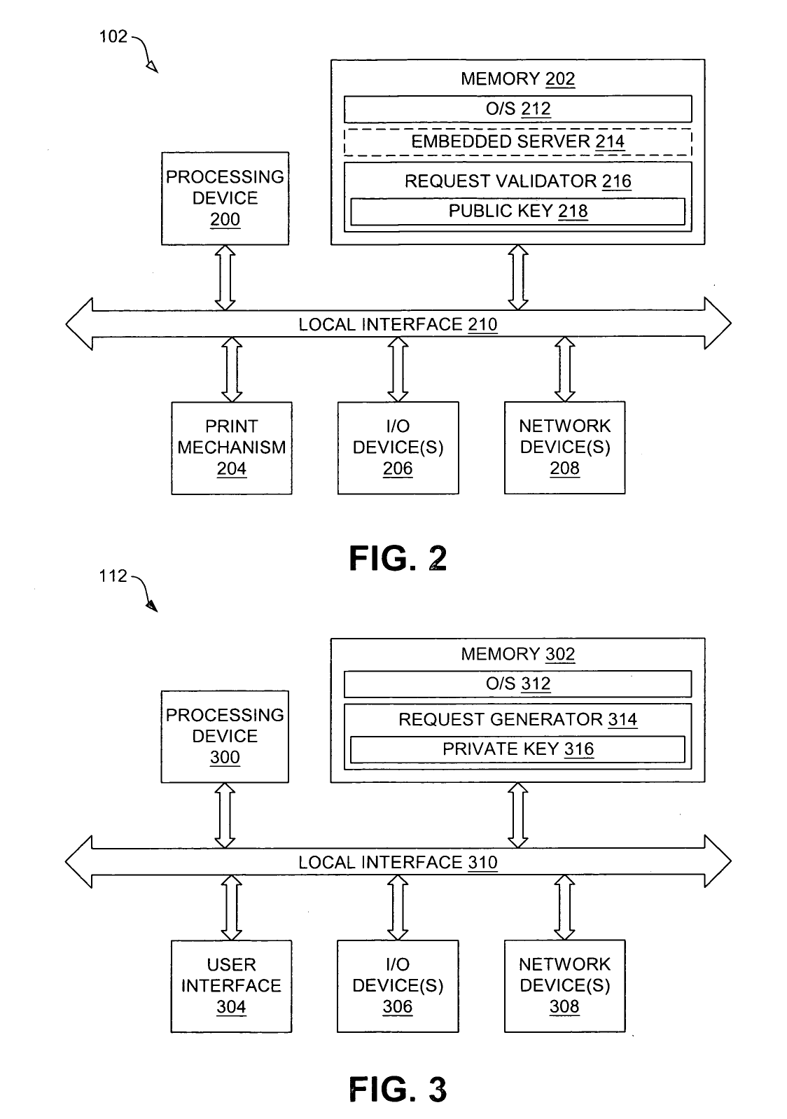

FIG. 2 is a block diagram illustrating an example architecture for the printing devices 102 shown in FIG. 1. As indicated in FIG. 2, each printing device 102 can comprise a processing device 200, memory 202, print mechanism 204, one or more input/output (I/O) devices 206, and one or more network devices 208. Each of those components is connected to a local interface 210 that, by way of example, comprises one or more internal buses.

The processing device 200 is adapted to execute commands stored in memory 202 and can comprise a general-purpose processor, a microprocessor, one or more application-specific integrated circuits (ASICs), a plurality of digital logic gates, or other electrical components that coordinate the overall operation of the printing device 102. The memory 202 can include any one or a combination of volatile memory elements (e.g., random access memory (RAM)) and nonvolatile memory elements (e.g., hard disk, compact disc read only memory (CDROM), etc.).

The print mechanism 204 comprises the components with which the printing device 102 generates hard copy documents. By way of example, the mechanism 204 comprises a formatter, a print engine, and various printing hardware (e.g., laser, drums, rollers, fuser, etc. in the case of a laser printing device) that physically convey print media through the printing device 102 and apply toner to those media.

The one or more I/O devices 206 comprise the components used to facilitate connection of the printing device 102 to other devices and therefore, for instance, comprise one or more serial, parallel, small system interface (SCSI), or universal serial bus (USB) connection elements. The network devices 208 comprise the components used to transmit and/or receive data over a network (e.g., network 104, FIG. 1) such as, for example, a network card.

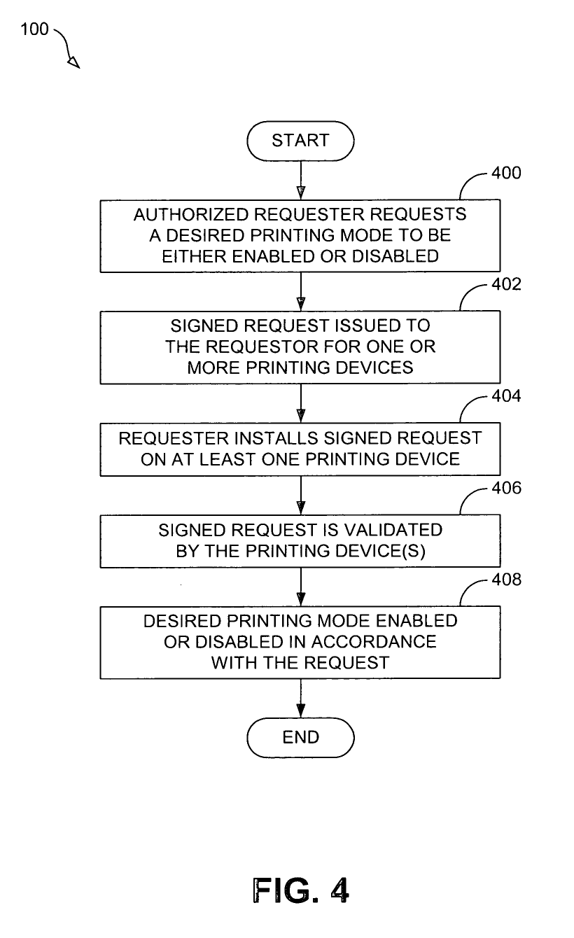

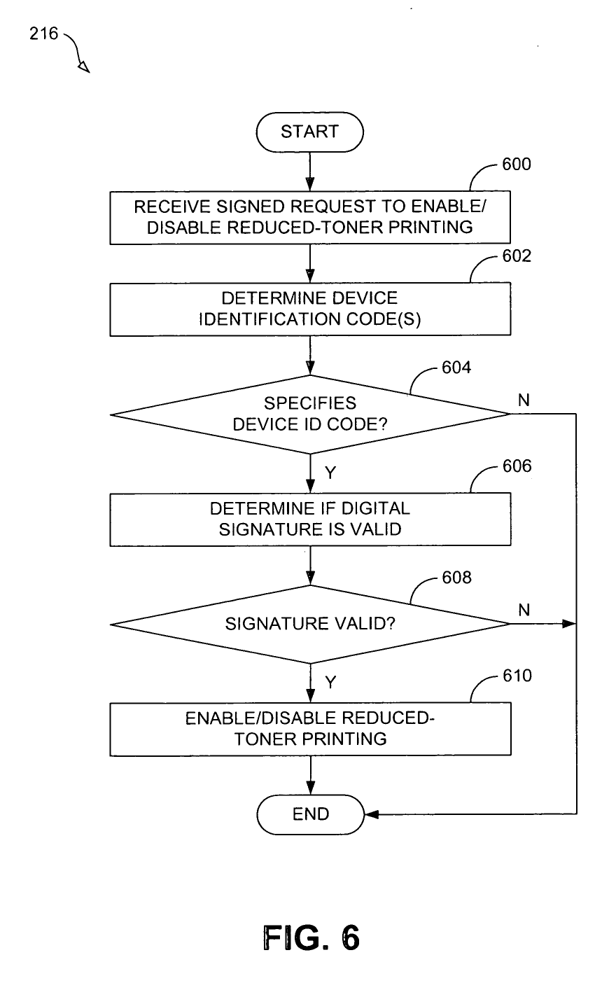

The memory 202 includes various programs (in software and/or firmware) including an operating system (O/S) 212 that contains various commands that are used to control the general operation of the printing device 102. In addition, the memory 202 can, optionally, include an embedded server 214 that generates one or more interface pages to which users may browse to change device settings or evaluate device status. In addition, the memory 202 includes a request validator 216 that, as is described in relation to FIGS. 4 and 6, validates received requests to change a printing mode and, if such requests are deemed valid, change the subject printing mode. As shown in FIG. 2, the request validator 216 may comprise a public key 218 that is used in the validation process.

FIG. 3 is a block diagram illustrating an example architecture for the server computer 112 shown in FIG. 1. As indicated in FIG. 3, the server computer 112 comprises a processing device 300, memory 302, one or more user interface devices 304, one or more I/O devices 306, and one or more network devices 308, each of which is connected to a local interface 310.

The processing device 300 can include any custom-made or commercially-available processor, a central processing unit (CPU), an auxiliary processor among several processors associated with the server computer 112, or a semiconductor based microprocessor (in the form of a microchip). The memory 302 can include any one or a combination of volatile memory elements (e.g., RAM) and nonvolatile memory elements (e.g., hard disk, CDROM, etc.).

The one or more user interface devices 304 comprise those components with which a user (e.g., system administrator) can directly interact with the server computer 112. Those components can comprise components that are typically used in conjunction with a PC, such as a keyboard, a mouse, and a monitor. The one or more I/O devices 306 and network devices 308 can, optionally, be similar to those like-named components described above with reference to FIG. 2.

The memory 302 normally comprises various programs (in software and/or firmware) including at least an O/S 312 and a request generator 314. The O/S 312 controls the execution of other programs and provides scheduling, input-output control, file and data management, memory management, and communication control and related services. The request generator 314 generates signed requests to be provided to one or more printing devices (e.g., devices 102, FIG. 1) that request that a printing mode of the device(s) be changed. As indicated in FIG. 3, the request generator 314 may comprise a private key 316 that is used in the request generation process. In such cases, the private key 316 corresponds to the public key 218 (FIG. 2) of the printing devices 102.

Various programs (i.e., logic) have been described above. It is to be understood that those programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Example systems having been described above, control over printing modes using such systems will now be discussed. In the discussions that follow, flow diagrams are provided. Any process steps or blocks in these flow diagrams may represent modules, segments, or portions of code that include one or more executable instructions for implementing specific logical functions or steps in the process. Although particular example process steps are described, alternative implementations are feasible. For instance, some steps may be executed out of order from that shown and discussed depending on the functionality involved.

FIG. 4 illustrates an overview of an embodiment of controlling printing modes. More particularly, FIG. 4 illustrates operation of the system 100 of FIG. 1 in facilitating such control. Beginning with block 400, an authorized requester, such as a service provider who maintains the printing devices 102, requests a desired printing mode be either enabled or disabled for one or more of the printing devices. By way of example, the printing mode can be a reduced-toner printing mode in which less toner is used to generate hard copy outputs from the devices.

Assuming that the requester is in fact authorized to request such enabling or disabling of the printing mode, a signed request is issued to the requester for one or more of the printing devices 102, as indicated in block 402. As is described in greater detail below, the signed request may comprise a secure file that is used by the printing devices 102 to determine whether to enable or disable the printing mode at issue.

Once the signed request is issued to the requester, the requester installs the request on at least one printing device 102, as indicated in block 404. Such installation can be achieved in various ways. Irrespective of the manner in which the signed request is installed, however, the signed request is validated by the printing device(s) 102, as indicated in block 406. Assuming that the request is valid for the particular printing device or devices 102 on which the request is installed, the desired printing mode is enabled or disabled in accordance with the request, as indicated in block 408.

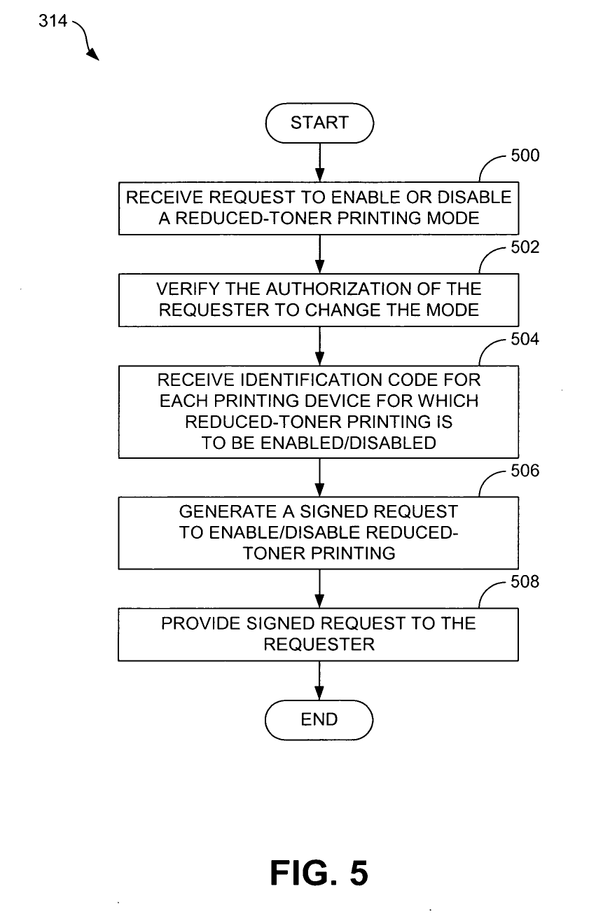

FIG. 5 illustrates an embodiment of operation of the request generator 314 of the server computer 112 in generating a signed request to control a printing mode and, more particularly, enable or disable reduced-toner printing. Beginning with block 500 of that figure, the request generator 314 receives a request to either enable or disable reduced-toner printing. Again, by way of example, the request may have been made by a service provider who is responsible for maintaining the printing device(s).

Referring next to block 502, the request generator 314 verifies the authorization of the requester (the service provider in this example) to change the printing mode. Such verification may comprise, for example, receiving a username and password that has been assigned to the service provider through a previously-performed registration process. Assuming that the service provider is authorized to change the printing mode (i.e., to enable or disable toner-reduced printing in this example), the request generator 314 receives an identification code for each printing device for which reduced-toner printing is to be enabled or disabled, as indicated in block 504.

The nature of the identification codes may depend upon the particular implementation. Regardless, the codes identify the individual printing devices at issue with particularity. Example identification codes include formatter serial numbers, print engine serial numbers, and media-access control (MAC) addresses. The service provider may obtain the identification codes in various ways. For instance, the service provider may use specialized software that performs printer management language (PML) or simple network management protocol (SNMP) queries. Alternatively, the identification codes may be obtained by browsing to interface pages hosted by embedded servers (e.g., server 214, FIG. 2) or by using an administrative program that is configured to manage the printing devices. By way of example, any of those methods may be practiced using a local computing device (e.g., computing device 106, FIG. 1) or a remote computing device (e.g., computing device 110, FIG. 1), assuming the computing device can be used to access the printing devices. Notably, the identification codes may otherwise be obtained by physically locating the codes noted on the printing devices.

The service provider can also provide the identification codes to the request generator 314 in various ways. For example, the service provider may browse to a network (e.g., Web) site supported by the server computer 112 and manually enter the identification codes in an appropriate field in that site. Alternatively, the service provider may upload a file containing the identification codes to the request generator 314, for example using the network site or using a specialized program (e.g., executing on computing device 106 or 110, FIG. 1) that is designed to programmatically provide the identification codes to the request generator. In still another alternative, the service provider may simply communicate the identification codes to an appropriate administrator that administers the request generator 314 and who can manually input the codes into the generator.

In some embodiments, other information besides the identification code(s) may be provided to the request generator 314. Such information may, for instance, comprise information regarding when the requested mode is to expire (potentially on a per-device basis) in terms of an expiration time or an expiration relative to usage (e.g., number of printed pages). It may be useful to provide such information in cases in which the service provider would like to, for instance, disable toner-reduced printing at the expiration of a given service contract. Other information that may be provided includes the identity of the service provider's client and the identity of the service provider (if not already provided in the authorization process in block 502).

With reference next to block 506, the request generator 314 then generates a signed request to either enable or disable toner-reduced printing, depending upon the service provider's wishes. The signed request is a file that comprises a digital signature that is generated by a signing process. The digital signature may be generated using the information that was provided to the request generator 314 including, for example, the identification code(s), expiration information, the client identity, and the service provider identity. Notably, if a signed request is to be installed on more than one printing device, there will be multiple identification codes, at least one code being specified for each printing device. A distinct digital signature can be generated for each printing device, or a single digital signature can be generated for all of a group of printing devices. By way of example, the digital signature is generated using the private key 316, which is a closely-guarded secret of the request generator host (e.g., printing device manufacturer). Such a private key may be used to encrypt a digest generated from the identification code(s), request that is being made, and the other information described above (e.g., expiration information, etc.).

Once the signed request has been generated, the request generator 314 provides the request to the requestor (i.e., the service provider in this example), as indicated in block 508, for the purpose of installing the signed request on one or more printing devices. Such provision can be effected in various ways and may depend upon the manner in which the service provider conveyed the identification code(s) (and any other information) to the request generator 314. Although not indicated in FIG. 5, the signed request could be transmitted to one or more of the printing devices directly if the request generator 314 can access those printing devices. In addition to the encrypted information, the signed request (file) comprises unencrypted information that can be used both to ensure that the request is intended for the printing device to which it is provided (e.g., identification code) and information that is necessary to decrypt the encrypted information that is not “known” to the printing device (e.g., the request that is being made, expiration information, etc.).

FIG. 6 illustrates an embodiment of operation of the request validator 216 of a printing device 102 on which reduced-toner printing is to be enabled or disabled. Beginning with block 600, the request validator 216 receives a signed request to enable or disable reduced-toner printing. That receipt occurs as a result of an installation process that is used to install the signed request on the printing device 102. By way of example, installation may comprise one of accessing an interface page hosted by the printing device 102, accessing the printing device using an administrative program that is used to control the printing device, or specifying PML or SNMP variables in a print job sent to the printing device.

Once the signed request is installed, the request validator 216 determines the identification code(s) contained in the request (i.e., the file), as indicated in block 602. As noted above, this and other information is not encrypted and therefore may be determined by the printing device without out first performing decryption. From that determination, the request validator 216 can confirm that the request is intended for the printing device on which the validator executes by confirming that the printing device's identification code is specified in the request. With reference to decision block 604, if the printing device's identification code is not so specified, the request is considered invalid and flow is terminated such that no printing mode change is made.

If, on the other hand, the printing device's identification code is specified in the request, flow continues to block 606 at which the request validator 216 determines if the digital signature of the request is valid. By way of example, this is accomplished using the public key 218 to decrypt the digital signature. Such decryption comprises generating a digest using the known identification code of the printing device, the request that is being made, and any other unencrypted information that is included in request file and that was used to generated the digital signature. Next, the validator 216 decrypts the encrypted portion of the request to recreate the digest generated by the request generator 314. Finally, the validator 216 compares the two digests and, if they match, concludes that the request is valid and therefore can be trusted. With reference next to decision block 608, if the digital signature is not valid, the signed request is considered invalid and flow is terminated. If, however, the digital signature is determined to be valid, flow continues to block 610 and reduced-toner printing is enabled or disabled in accordance with what is requested. Notably, if an expiration time was provided to the request generator 314, and therefore used to generate the signed request, the request validator 216 enables such expiration by storing the expiration time to memory 202. In such a case, the printing mode (either reduced-toner printing mode or standard printing mode) will revert to the mode that was active prior to the change upon reaching the expiration time.

Although reduced-toner printing has been cited as an example of a printing mode that can be controlled using the above-described systems and methods, other printing modes can be similarly controlled. One such other mode, for instance, is so-called CMYK printing in which the user may select the settings for the various color toners used in the printing device. As with reduced-toner printing, it may be desirable to extend control over that functionality to particular users, for example printing professionals who are most likely to obtain positive results from CMYK printing.

1. A method for controlling a printing mode, the method comprising:
receiving a request to change a printing mode of a printing device;
generating a signed request that requests changing of the printing mode;
validating the signed request; and
enabling or disabling the printing mode in accordance with the signed request if the signed request is valid.

2. The method of claim 1, wherein receiving a request to change a printing mode comprises receiving a request from a service provider who maintains the printing device.

3. The method of claim 1, wherein generating a signed request comprises generating a signed request using a request generator that executes on a network-accessible server computer.

4. The method of claim 1, wherein generating a signed request comprises generating a signed request that includes an identification code of the printing device.

5. The method of claim 4, wherein generating a signed request comprises generating a signed request that further includes at least one of an expiration time, an identification of a client, and an identification of a service provider.

6. The method of claim 1, wherein generating a signed request comprises generating a digital signature using a private key.

7. The method of claim 6, wherein generating a digital signature comprises generating a digital signature using an identification code of the printing device.

8. The method of claim 1, wherein validating the signed request comprises validating the signed request using a request validator that executes on the printing device.

9. The method of claim 1, wherein validating the signed request comprises determining if a digital signature of the signed request is valid.

10. The method of claim 9, wherein determining if a digital signature is valid comprises decrypting the digital signature using a public key.

11. The method of claim 1, wherein enabling or disabling the printing mode comprises enabling or disabling reduced-toner printing.

12. The method of claim 1, wherein enabling or disabling the printing mode comprises enabling or disabling CMYK printing.

13. A system for controlling a printing mode, the system comprising:
means for generating a signed request that requests changing of a printing mode of a printing device;
means for validating the signed request on the printing device; and
means for enabling or disabling the printing mode.

14. The system of claim 13, wherein the means for generating a signed request comprise a request generator that executes on a network-accessible server computer.

15. The system of claim 13, wherein the means for generating a signed request comprise means for generating a digital signature using an identification code of the printing device.

16. The system of claim 13, wherein the means for generating a digital signature comprise a private key.

17. The system of claim 13, wherein the means for validating the signed request comprise a request validator that executes on the printing device.

18. The system of claim 17, wherein the request validator is configured to decrypt a digital signature of the signed request using a public key stored in the printing device.

19. The system of claim 13, wherein the means for enabling or disabling the printing mode comprise means for enabling or disabling reduced-toner printing.

20. A system stored on a computer-readable medium, the system comprising:
logic configured to generate a signed request on a server computer;
logic configured to validate the signed request on a printing device; and
logic configured to enable or disable a printing mode on the printing device in accordance with the signed request.

21. The system of claim 20, wherein the logic configured to generate a signed request comprises logic configured to generate a digital signature using a private key and an identification code of the printing device.

22. The system of claim 20, wherein the logic configured to validate the signed request comprises logic configured to determine if a digital signature of the signed request is valid using a public key.

23. A request generator stored on a computer-readable medium, the generator comprising:
logic configured to receive a request from a service provider to change a printing mode of a printing device;
logic configured to verify the authorization of the service provider; and
logic configured to generate a signed request that is configured for installation on the printing device and that requests changing of the printing mode.

24. The generator of claim 23, wherein the logic configured to receive a request is further configured to receive an identification code of the printing device.

25. The generator of claim 24, wherein the logic configured to generate is configured to generate a digital signature that is based upon the identification code.

26. The generator of claim 25, wherein the logic configured to generate is configured to generate the digital signature using a private key.

27. The generator of claim 23, further comprising logic configured to provide the signed request to the service provider.

28. A request validator stored on a computer-readable medium, the validator comprising:
logic configured to receive a signed request that requests changing of a printing mode;
logic configured to determine an identification code comprised by the signed request;
logic configured to determine if a digital signature of the signed request is valid; and
logic configured to enable or disable the printing mode.

29. The validator of claim 28, wherein the logic configured to determine if a digital signature of the signed request is valid comprises logic configured to decrypt the digital signature using a public key that is associated with a private key that was used to generate the digital signature.

30. The validator of claim 28, wherein the logic configured to enable or disable the printing mode comprises logic configured to enable or disable reduced-toner printing.

31. The validator of claim 27, wherein the logic configured to enable or disable the printing mode comprises logic configured to enable or disable CMYK printing.

32. A printing device, comprising:
a processing device;
a print mechanism; and
memory that includes a request validator, the request validator being configured to receive a signed request that requests changing of a printing mode, determine if a digital signature of the signed request is valid, and enable or disable the printing mode if the signed request is valid.

33. The device of claim 32, wherein the request validator is configured to decrypt the digital signature using a public key that is associated with a private key that was used to generate the digital signature.

34. The device of claim 32, wherein the request validator is configured to enable or disable reduced-toner printing.

35. The device of claim 32, wherein the request validator is further configured to determine an identification code comprised by the signed request and compare it to an identification code of the printing device.
